(19) United States
(12) Patent Application Publication
(10) Pub. No.: US 2014/0261079 A1
(43) Pub. Date: Sep. 18, 2014

(54) POLYSILAZANES AS ANTI-STRIP AGENTS FOR ASPHALT

(71) Applicant: Heritage Research Group, Indianapolis, IN (US)

(72) Inventors: Sibel Selcuk, Westfield, IN (US); Perry Eyster, Brownsburg, IN (US)

(21) Appl. No.: 14/204,720

(22) Filed: Mar. 11, 2014

Related U.S. Application Data
(60) Provisional application No. 61/779,286, filed on Mar. 13, 2013.

(51) Int. Cl. C08L 95/00

(52) U.S. Cl. CPC C08L 95/00
USPC 106/284.06

(57) ABSTRACT

Asphalt binders which contain polysilazanes that are produced by reacting chlorosilanes with ammonia and other optional solvents. Sources for the chlorosilanes include waste chlorosilanes such as direct process residue. The polysilazanes function as anti-stripping agents.

### RELATED APPLICATION

The present application is based on U.S. Provisional Application Ser. No. 61/779,286, filed Mar. 13, 2013 to which priority is claimed under 35 U.S.C. §120.

### BACKGROUND

The present invention relates generally to anti-strip agents for asphalt. More particularly the present invention is directed to polysilazanes that are used as anti-strip agents and methods of preparing the polysilazanes and asphalt binders and compositions that contain the polysilazanes.

Polysilazanes are polymers in which silicon and nitrogen atoms form basic backbones. Since each silicon atom can be bound to multiple nitrogen atoms and each nitrogen atom can be bound to multiple silicon atoms, complex chains, rings, and macromolecules are possible.

The production of polysilazane from chlorosilanes is well understood and documented.

Polysilazane can be synthesized by reacting ammonia with chlorosilanes. In this ammonolysis reaction, large quantities of ammonium chloride are produced and must be removed from the reaction mixture. The reaction proceeds as follows:

RSiCl₂+3NH₃→1/n[RSi—NH]n+2NH₄Cl

In the laboratory, the reaction is normally carried out in a dry organic solvent since polysilazanes decompose in the presence of water or moisture and the ammonium chloride is removed by filtration from the reaction mass.

According to a liquid-ammonia-procedure chlorosilane or chlorosilane mixtures are simultaneously added to an excess of liquid ammonia. The resulting ammonium chloride dissolves in the liquid ammonia and phase separates from the polysilazanes.

Efforts have also been made to utilize this chemistry in producing valuable polysilazanes from chlorosilane wastes known in the industry as Direct Process Residue, or DPR.

Direct Process” or “Rochow Process” refers to an indirect way of making chlorosilanes from Me—Cl via the Grignard reagent RMgCl. This process is described by Rochow in U.S. Pat. No. 2,380,995 and in U.S. Pat. No. 2,488,487 by Barry et al. As a result of the Direct Process several chlorosilane monomers and oligomers are produced in side reactions. The byproduct monomers typically consist of a mixture of methyltrichlorosilanes, trimethylcholorosilanes, and methydichlorosilanes. The oligomers include a high boiling blend of disilanes, silmethylenes and polysilalkylenes also known as “Direct Process Residue” or “DPR.” The high boiling fraction may also contain particulate silicon and metals or compounds thereof. The Direct Process generates one of the largest organosilane by-products streams and is generally considered as a waste stream due to the lack of sufficient commercial use of the chlorosilanes and because of the composition of the mixture.

To date, the polysilazanes produced from DPR have been evaluated by Verbeek in U.S. Pat. No. 3,853,567 and Baney et al in U.S. Pat. No. 4,314,956 in the production of polysilazane intermediates, preceramic and ceramic materials. Gaul treated chlorine containing disilanes with ammonia at elevated temperatures to make silazane polymers in U.S. Pat. No. 4,395,460. The present invention utilizes the polysilazanes directly in asphalt as an adhesion promoter, or anti-strip. Abel et al. in U.S. Pat. No. 6,329,487 describe the process of using excess ammonia to separate the ammonium chloride salt from the polysilazane. Bituminous materials, sometimes referred as bitumen and also known as asphalt binder, is used as a binder in asphalts to pave roads and other surfaces and is used in other construction materials such as roofing materials, coatings, waterproofing applications, sealants, etc. Examples of bitumen that may be used in compositions and methods of present invention include natural bitumens, pyrobitumens, and artificial bitumens. Bitumens that are particularly preferred are those used for roadways, such as asphalt or malta.

Anti-strip agents, also referred to more generally as adhesion promoters, are used to improve the bond between asphalt cements and the aggregates they are mixed with for road paving applications. These materials are also used to inhibit the damaging effects of moisture in asphalt pavements. Adhesion promoters are most commonly used in hot-mix asphalt (HMA). In other applications anti-strip agents can be used in bituminous sealants.

Nearly all anti-strips are asphalt additives, as opposed to aggregate pre-coats, and may directly affect the rheology of the asphalt. Any additive with a lower viscosity will impart a concurrent reduction in viscosity on the asphalt blend.

Moisture damage, also referred to as stripping, occurs due to loss of adhesion between the asphalt binder and aggregate and/or loss of cohesion within the asphalt binder. Measures to prevent such failure have included the addition of anti-strip agents to HMA mixtures. Premature failure of HMA pavements due to stripping has been a major problem for state highway departments since the 1970s.

The effectiveness of anti-strip agents in asphalt for reducing asphalt stripping in the presence of moisture can be defined as how well they perform in reducing or preventing the loss of adhesion of the asphalt with the mineral aggregate. Effective anti-strip agents can extend the service life of pavements which might otherwise fail due to the effect of moisture-induced damage.

The present invention is based upon investigations that have concluded that polysilazanes, including those produced from chlorosilanes and chlorosilane wastes such as DPR, are both stable and beneficial when blended in asphalt.

### BRIEF SUMMARY

According to various features, characteristics and embodiments of the present invention which will become apparent as the description thereof proceeds, the present invention provides a method of preparing an asphalt binder which comprises the steps of:

reacting at least one type of chlorosilane with ammonia to produce polysilazanes; and

combining the polysilazanes with asphalt binder.

The present invention further provides an asphalt composition made from the asphalt binder and a pavement made from the asphalt composition.

The present invention also provides a method of preparing an asphalt composition which comprises the steps of:

a) preparing an asphalt binder by reacting at least one type of chlorosilane with ammonia to produce polysilazanes and combining the polysilazanes with asphalt binder; and

b) combining the asphalt binder with aggregate.

### DETAILED DESCRIPTION OF THE PRESENTLY PREFERRED EMBODIMENTS

The present invention is directed to anti-strip agents for asphalt. More particularly the present invention is directed to polysilazanes that are used as anti-strip agents and methods of preparing the polysilazanes and asphalt compositions that contain the polysilazanes.

According to one aspect of the present invention polysilazanes are produced by reacting waste chlorosilanes such as DPR with ammonia the resulting mixture of polysilazanes are then added to hot liquid asphalt which can then be used to produce HMA. At least about 0.25 weight percent and preferably about 0.25 to about 3.0 weight percent and more preferably about 0.25 to about 0.75 weight percent of the polysilazane mixture can be added to the liquid asphalt. The HMA can be prepared by any conventional manner using commercially available equipment. Any suitable aggregate can be used in preparing the HMA. According to one aspect of the present invention it was determined that the polysilazanes are particularly suitable for HMA that include high silica aggregate. The HMA that include the polysilazanes of the present invention can be used to make any type of pavement including, but not limited to, roadways, walkways, parking lots, etc.

The reaction of DPR with ammonia according to the present invention uses excess ammonia. Anhydrous ammonia was determined to be particularly useful for purposes of the present invention as it acts as both a reactant and solvent. The resultant ammonium chloride has its own intrinsic value and is recovered as an additional product. In other embodiments an additional solvent(s) can be used.

During the course of the present invention DPR was reacted with anhydrous ammonia and the resulting polysilazane product was blended with HMA which was subsequently subject to stability evaluation. Testing included separation testing, viscosity testing, low temperature response and adhesiveness.

As discussed below, testing confirmed the stability of the polysilazane in asphalt and also confirmed that the polysilazane polymers continue to condense within the asphalt which leads to increased viscosity without adversely affecting low temperature response of the HMA.

The present invention this provides for use of DPR (or other chlorosilane wastes) which is otherwise considered a process waste by-product which enhances the properties of HMA.

While the HMA containing polysilazanes can incorporate any conventional type of aggregate, during the course of the present invention it was found that the polysilazane acts particularly well as an adhesion promoter between the asphalt and high silica aggregate.

### Example

Approximately 300 mL anhydrous ammonia was delivered to a non-pressurized reaction flask held at a temperature of −78° C. in a dry ice/acetone bath. One hundred-fifty grams of DPR was then delivered below the fluid line using a small tubing pump at a rate of approximately 10-15 mL per minute with gentle agitation. Anhydrous ammonia was intermittently replenished as ammonia was consumed. As the polysilazane phase separated from the excess ammonia, the ammonia supernatant was decanted. Three successive rinses using anhydrous ammonia dissolved and removed the ammonium chloride that had precipitated in the supersaturated solution. The final ammonia rinse was decanted and the polysilazane product was collected in a vented flask. The flask was left to stand overnight and allow any residual ammonia to evaporate. The following morning, the sample was weighed to determine yield. Forty-seven grams of polysilazane was recovered for an effective yield of 53% of theoretical. The polysilazane was then blended at various percentages by weight with a standard paving grade asphalt.

Samples of the blends were subjected to separation testing, viscosity testing, low temperature response and adhesiveness on high silica aggregate and/or crushed granite.

Separation testing following ASTM D7173-11 confirmed that the polymer is both soluble and stable in asphalt. The results presented a 2.9° F. difference in melt temperature.

Viscosity testing was conducted following ASTM D7175-08 on a TA Instruments AR1500ex Dynamic Sheer Rheometer yielding the following results:

Dynamic Shear Rheometer

| | Polysilazane, % | | | | |
|---|---|---|---|---|---|
| | 0 | 0.75 | 1.25 | 2.0 | 3.0 |
| Fail Temp., ° C. | 65.19 | 68.01 | 69.32 | 70.71 | 68.94 |

Low temperature response was conducted following ASTM D6648-08 on a Cannon Thermoelectric Bending Beam Rheometer. A sample of PG 64-22 asphalt blended with 2.0% polysilazane, by weight, recorded a fail temperature of −22° C.

Adhesiveness testing was conducted according to the Texas Boil method in which the samples are exposed to boiling water for 10 minutes. During this exposure any asphalt binder that is stripped away floats to the surface of the water. After cooling to room temperature the coated aggregate is visually inspected and given a rating in terms of percentage of binder remaining adhered to the aggregate.

The results of the sample testing and a control sample which did not contain any polysilazanes are provided in Table 1 as follows:

TABLE 1
Texas Boil, Granite

Polysilazane, %

| | 0 | 0.25 | 0.75 | 1.25 |
|---|---|---|---|---|
| Asphalt Coating, % | 25 | 95 | 98 | 100 |

The testing which was conducted confirmed the stability of the polysilazane in asphalt by separation testing. Additional testing has demonstrated that the polysilazane polymer continues to condense within the asphalt and leads to increased viscosity without adversely affecting low temperature response. More importantly, the polysilazane acts as an adhesion promoter between the asphalt and high silica aggregate. The Texas Boil testing confirmed 100% adhesion by visual inspection for 1.25% polysilazane blends when coating crushed granite. In contrast the control asphalt yielded approximately 25% adhesion by visual inspection.

It is to be understood that the use of polysilazanes as anti-strip agents for asphalt compositions according to the present invention is not limited to polysilazanes that are produced by the reaction of chlorosilanes, including mixtures of chlorosilanes such as DPR, with ammonia using ammonia alone as a solvent or using other dry organic solvents such as hexane, toluene, and xylene.

Although the present invention has been described with reference to particular means, materials and embodiments, from the foregoing description, one skilled in the art can easily ascertain the essential characteristics of the present invention and various changes and modifications can be made to adapt the various uses and characteristics without departing from the spirit and scope of the present invention as described above and set forth in the attached claims.

1. A method of preparing an asphalt binder which comprises the steps of:
a) reacting at least one type of chlorosilane with ammonia to produce polysilazanes; and
b) combining the polysilazanes with asphalt binder.

2. A method of preparing an asphalt binder according to claim 1, wherein step a) comprises reacting chlorosilane waste with ammonia to produce a mixture of polysilazanes.

3. A method of preparing an asphalt binder according to claim 2, wherein the chlorosilane waste comprises direct process residue.

4. A method of preparing an asphalt binder according to claim 1, wherein in step a) anhydrous ammonia is reacted with the at least one type of chlorosilane.

5. A method of preparing an asphalt binder according to claim 1, wherein in step b) about 0.25 to about 3.0 weight percent of the polysilazanes were combined with the asphalt binder.

6. A method of preparing an asphalt binder according to claim 1, wherein a solvent other than ammonia is present in step a).

7. An asphalt composition that comprises the asphalt binder of claim 1 combined with aggregate material.

8. A pavement made from the asphalt composition of claim 5.

9. A method of preparing an asphalt composition which comprises the steps of:
a) preparing an asphalt binder by reacting at least one type of chlorosilane with ammonia to produce polysilazanes and combining the polysilazanes with asphalt binder; and
b) combining the asphalt binder with aggregate.

10. A method of preparing an asphalt composition according to claim 9, wherein the asphalt binder is prepared by reacting chlorosilane waste with ammonia to produce a mixture of polysilazanes.

11. A method of preparing an asphalt composition according to claim 9, wherein the chlorosilane waste comprises direct process residue.

12. A method of preparing an asphalt composition according to claim 9, wherein the asphalt binder is prepared by reacting anhydrous ammonia with the at least one type of chlorosilane to produce the polysilazanes.

13. A method of preparing an asphalt composition according to claim 9, wherein the asphalt binder is prepared by combining about 0.25 to about 1.25 weight percent of the polysilazanes with the asphalt binder.

14. A method of preparing an asphalt composition according to claim 9, wherein a solvent other than ammonia is present in the reaction in step a).

15. A pavement made from the asphalt composition of claim 9.
